(19) United States
(12) Patent Application Publication
(10) Pub. No.: US 2009/0179993 A1
(43) Pub. Date: Jul. 16, 2009

(54) SYSTEM FOR DETECTING MOVEMENT OF A CAMERA, CAMERA COMPRISING A SYSTEM FOR DETECTING MOVEMENT OF A CAMERA

(75) Inventor: Cristian Presura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,502

(22) PCT Filed: Sep. 13, 2005
(86) PCT No.: PCT/IB05/52995

§ 371 Date: Mar. 19, 2007

(30) Foreign Application Priority Data
Sep. 22, 2004 (EP) 04104590.7

(51) Int. Cl. H04N 5/228

(52) U.S. Cl. 348/208.1; 348/E05.031

(57) ABSTRACT

A system for detecting movement of a camera having a variable optical element (2). The system comprises a beam splitter (7) for capturing a part of the light traversing the lens and for splitting into at least a pair of light beams (8, 10). For each of the light beams the system comprises a light sensor (9, 11). Each sensor is provided with a grating (9g, 11g) in the light path for each of the light sensors. The gratings of the sensors have substantially the same pitch, but are positioned with a shift (S) that in respect of the light beam impinging on said sensor differ. The system further comprising a comparator (5) for comparing time shifted signals from the light sensors.

The invention relates to a system for detecting movement of a camera having a variable optical element. Such systems are used in or for a camera to detect movement of a camera. Detection of the movement is used for instance for automatically compensating for shaking of a picture when shooting a video camera by varying the variable optical element. 5 Such a system is e.g. known from U.S. Pat. No. 5,170,255.

Advances in lowering the price of a consumer digital camera have led to a rapid replacement of film cameras. Even though very popular, especially consumer digital cameras still have a disadvantage when the camera is shaking when taking a picture, because then a blurred image may be obtained. This blurring distracts from the quality of the image giving an unpleasant impression to the viewer. Solutions include the presence of a variable optical element, such as e.g. a moving lens. The moving lens is conventionally actuated by separate gyroscopes, to maintain a constant image when taking the image. However, this is an indirect method, because it does not directly involve the image itself. U.S. Pat. No. 5,170,255 does provide a method in which the image itself on an image sensor, for example a CCD, is used. Differences between two sequentially taken images are compared. Characteristics of the images, for example edges in a predetermined vertical or horizontal line, are compared to provide an image shaking detection signal, which is used to actuate the variable optical element, which variable element in U.S. Pat. No. 5,170,255 is formed by a variable angle prism. Although the system from U.S. Pat. No. 5,170,525 does use the image itself for detecting movement it requires a complicated electronic system and the system is not fast.

It is an object of the invention to provide a system and a camera as described in the opening paragraph which is relatively simple and fast.

To this end the system in accordance with a first aspect of the invention is characterised in that it comprises a beam splitter which is positioned, seen in the optical path, behind the lens, for capturing a part of the light traversing the lens and for splitting the light falling through the beam splitter into at least a pair of light beams, the system further comprising at least a pair of light sensors for providing light signals, one sensor for each light beam, and a grating in the light path for each of the light sensors, wherein the gratings of the pair of sensors have substantially the same pitch, but are positioned with a shift that in respect of the light beam impinging on said sensor differ, the system further comprising a comparator for comparing time shifted signals from the light sensors.

Since use is made of light falling through the lens, the measurement is made directly on the image. It is not an indirect method.

The use of separate sensors, not of the image acquired by the CCD with which the actual image is taken, removes the restriction posed by the relatively long acquiring times of a CCD. In the system of U.S. Pat. No. 5,170,255 the speed of compensation is limited by the processing of the images itself. This restriction is removed, the sensors themselves are elements independent of the actual image CCD which allows much faster sensors to be used, and to consequently a faster better shaking compensation.

The invention is based on the following insight:

To identify the direction and the amount in which the movable lens or other variable optical element must be varied, at least two light beams are obtained using the beam splitter. One of the light beams of this pair goes to a first sensor, the second light beam to a second sensor. Both sensors are provided with gratings and the gratings have substantially the same pitch (i.e. the distance between elements of the grating). The grating of this second sensor, even though having substantially the same pitch as the grating of the first sensor, is shifted, for instance slightly misaligned, with respect to the light beam. Because the two gratings are spatially shifted in respect of the light beam falling on the sensor, the intensities on the pair of sensors are close, but not identical. If the image moves in the direction of the shift, at the right speed, then the second sensor receives the same intensity I₂=I₁ as it was received previously by the first sensor. If it moves in the other direction, the difference |I₂−I₁| will increase.

Thus, by monitoring the difference |I₂−I₁|, the direction in which the image is moving and the speed of such movement is detectable. Since the direction and speed is detectable the feedback loop works.

By keeping also the intensity I₁ constant using this information, the system is able to “lock” the moving image, by properly controlling a variable optical element actuator, such that the intensity on the first detector is constant.

In more complex embodiments the system and camera comprises one or more beam splitters for providing more than one pair of lights beams, wherein the system comprises for each beam splitter a corresponding pair of sensors. Using a pair of sensors it is possible to easily detect motion in one direction, namely the direction parallel to the shift. Using more pairs of sensors, preferably two it is possible to detect motion in more than one direction.

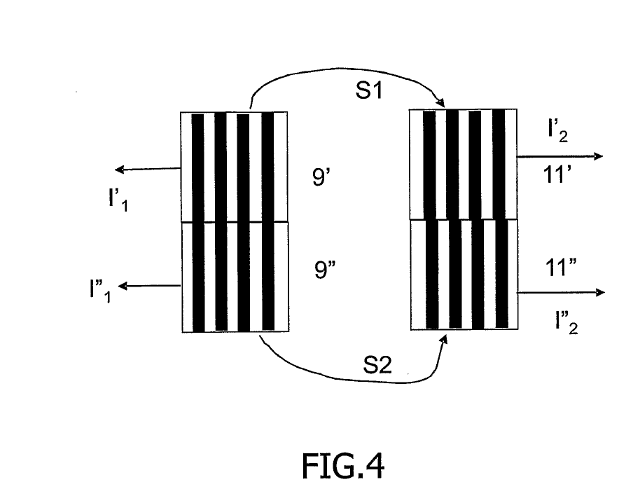

In preferred embodiments the pair of sensors is divided into two sub-sensors, wherein the pitch of the gratings of the sub-sensors differ. This enables a more accurate and fast determination of motion. Such embodiments are illustrated in FIG. 4 below.

In embodiments the beam splitter may split the beam into two beams which hit the two sensors simultaneously or it may alternating deflect a single beam to the two sensors.

In a second aspect of the invention the system is characterised in that it comprises a further variable optical element which is positioned, seen in the optical path, behind the lens, the system further comprising at least one light sensor for providing light signals, comprising a grating in the light path, wherein the variable element is arranged for changing as a function of time the position of the beam and the grating is respect of each other and the system further comprising a comparator for comparing time shifted signals from the sensor.

The second aspect has the advantage of needing less sensors, be it at the expense of the provision of a variable optical element.

These and further aspects of the invention will be explained in greater detail by way of example and with reference to the accompanying drawings, in which

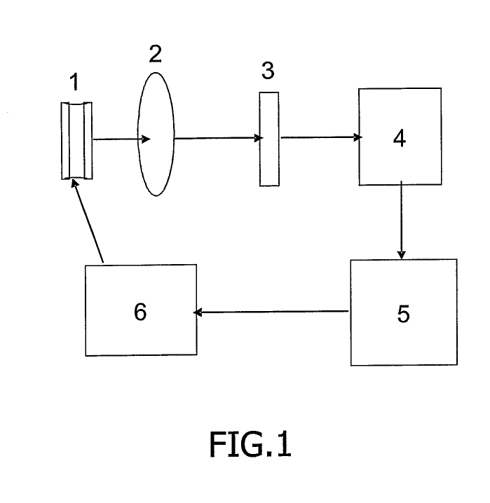

FIG. 1 illustrates a known system.

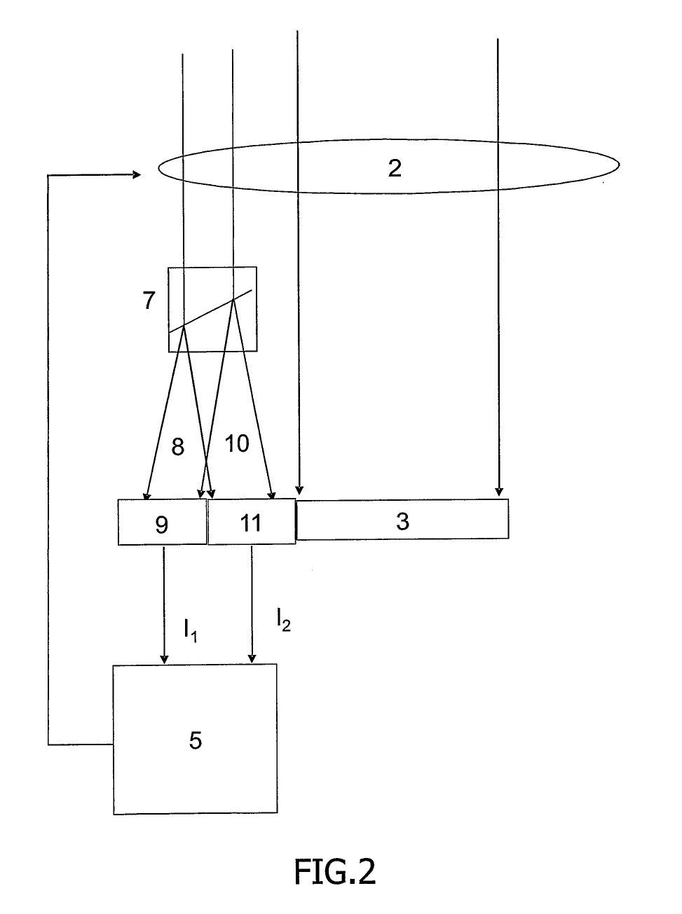

FIG. 2 illustrates a system in accordance with a first aspect of the invention.

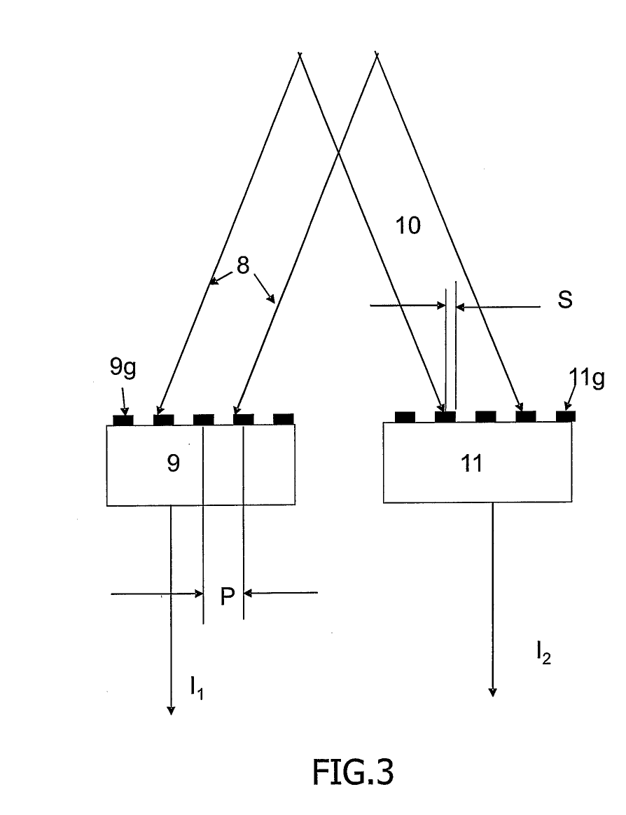

FIG. 3 illustrates a detail of a system in accordance with the invention.

FIG. 4 illustrates a further detail of a system in accordance with the invention.

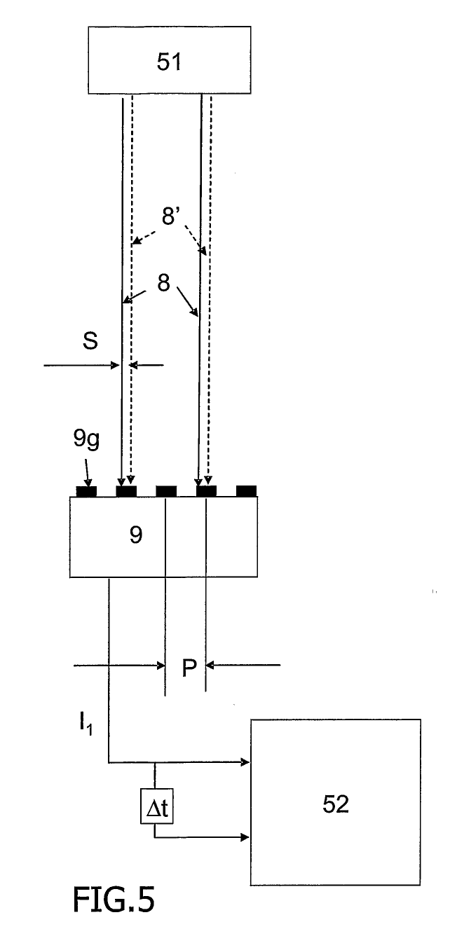

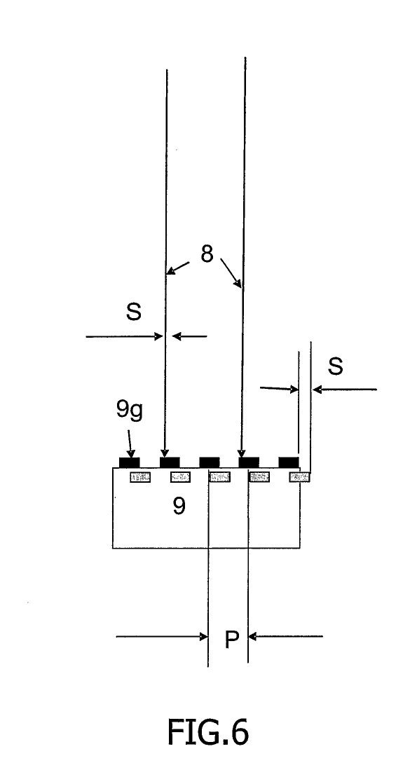

FIGS. 5 and 6 illustrates examples of a second aspect of the invention

The Figs. are not drawn to scale. Generally, identical components are denoted by the same reference numerals in the figs.

FIG. 1 illustrates schematically a known system for a camera. The system comprises a variable optical element such as a variable prism. The light traverses the prism 1 and a lens 2 (or more in general a further optical system which may be a set of lenses) forming an image on image sensor, e.g. a CCD array 3. The image sensor sends its signals to an image processor 4. In a shaking detector 5 signals from images taken slightly apart in time are analysed to provide a shaking signal, which is sent to drive 6 which drives the variable optical element 1. Using this general scheme it is possible to compensate for shaking.

Although such systems are known and are relatively successful, there are restriction on such systems. They are relatively complex and relatively slow. The speed with which shaking can be controlled is inherently limited by the speed with which the images are taken and processed and compared. The CCD image sensors which are used are relatively slow.

FIG. 2 illustrates a system in accordance with the invention. The system comprises a lens 2 and a image sensor 3, e.g. a CCD array. The system in accordance with the invention in this embodiment comprises a beam splitter 7, which is positioned behind the lens and splits a light beam passing the lens into two beams 8 and 10. The beam 8 impinges on a sensor 9, the beam 10 impinges on a sensor 11. Signals emanating from the sensors 9 and 11 are fed to a shaking detector 5, which determines shaking parameters, which in turn are used to control a variable optical element, e.g. a variable prism or a device to move the lens 2, to compensate for the shaking. The signals are generated by the sensors, which are dedicated to this task and thus can be arranged to deliver fast signals. For instance, in preferred embodiments the sensors are comprised of a single detector or a small group (2 to less than 10) subsensors. Such sensors are much faster than a CCD array. The shaking detector comprises a comparator for comparing time shifted signal I₁ and I₂.

FIG. 3 illustrates the embodiment of the invention as schematically shown in FIG. 2 in more detail. The sensors 9 and 11 are each provided with a grating 9g, 11g respectively, the pitch P of these grating is substantially the sensors. Said sensors and gratings are substantially the same but for one difference, the gratings 9g and 11g are shifted by a shift S in respect of the beams 8 and 10. As a result if the image moves in the direction of the shift S, at the right speed, then the second sensor receives the same intensity I₂=I₁ as it was received previously by the first sensor. If it moves in the other direction, the difference |I₂−I₁| will increase. Thus by monitoring the difference I₂(t+Δt)−I₁(t), i.e. time shifted signals form the sensors 9 and 11, the speed of shaking in the direction of the shift S is monitored. By keeping also the intensity I₁ constant using this information, the system is able to “lock” the moving image, by properly controlling a variable optical element actuator, such that the intensity on the first detector is constant.

The sensors 9 and 11 are independent sensors from the image sensor 3, and thus the restrictions due to a limited speed of said sensor are lifted.

The shift S is typically 0.1 to 5, preferably 0.1 to 0.5 of the size of a pixel of the CCD array 3.

In this simple embodiment two sensors are used.

FIG. 4 illustrates a slightly more complex example in which the sensors 9 and 11 comprise two sub-sensors 9′, 9″ and 11′, 11″ respectively. The shift between the gratings is different for one pair of subsensors 9′, 11″ (shift S1), than for the other pair of subsensors 11′, 11″ (shift S2). This allows for a more accurate determination of the speed. Using sensors with gratings it is possible to determine the speed of shaking parallel to the pitch of the grating. In preferred embodiment the device comprise more pairs of sensors wherein for one pair of grating the grating is oriented in a first direction (e.g. a horizontal direction) while for another pair of sensors the gratings are oriented in a direction transverse to the first direction, e.g. the vertical direction.

In this aspect of the invention two sensors are used.

A different aspect of the invention is shown in FIG. 5. In this aspect of the invention a single sensor with a single grating, but a variable optical element 51 (such as a variable mirror or variable prism) is used, for changing as a function of time the position of the beam and the grating is respect of each other. This scheme also provides for a shift S, if this shift S is in the direction of the shaking and at the right speed the intensity remains constant. Thus by monitoring time shifted signals, e.g. by comparing I₁ at time (t+Δt) to the signal I₁ at time t, e.g. using a comparator 52, as is schematically indicated in FIG. 5, the shaking speed perpendicular to the gratings may be obtained. A relative time dependent shift of beam and grating with respect to each other may be obtained by manipulating the beam (using e.g. a variable prism or mirror or movable lens) which is schematically shown in FIG. 5, or by moving the grating, which is schematically indicated in FIG. 6. A ‘moving’ grating may for instance be provided by means of a LCD array. Using an LCD array a image of transparent and non-transparent stripes may be provided, with, by altering the position of the transparent and non-transparent stripes, may form a ‘moving’ grating.

The advantage of using a single sensor is that any problems due differences in sensitivity of sensors are avoided. The disadvantage is that a variable optical element is to be used. A further disadvantage of this embodiment is that the rate of change must be fast, i.e. within time periods relatively small compared to the natural change in the image.

In short the invention may be described by:

A system for detecting movement of a camera having a variable optical element (2). The system comprises a beam splitter (7) for capturing a part of the light traversing the lens and for splitting into at least a pair of light beams (8, 10). For each of the light beams the system comprises a light sensor (9, 11). Each sensor is provided with a grating (9g, 11g) in the light path for each of the light sensors. The gratings of the sensors have substantially the same pitch, but are positioned with a shift (S) that in respect of the light beam impinging on said sensor differ. The system further comprising a comparator (5) for comparing time shifted signals from the light sensors.

In the second embodiment a further variable optical element (51) or a moving grating is used instead of a beam splitter.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. System for detecting movement of a camera having a variable optical element (2) wherein the system comprises a beam splitter (7) which is positioned, seen in the optical path, behind the lens (2), for capturing a part of the light traversing the lens and for splitting the light falling through the beam splitter (7) into at least a pair of light beams (8, 10), the system further comprising at least a pair of light sensors (9, 11) for providing light signals (I₁, I₂), one sensor for each light beam, and a grating (9g, 11g) in the light path for each of the light sensors, wherein the gratings of the sensors have substantially the same pitch (P), but are positioned with a shift (S) that in respect of the light beam impinging on said sensor differ, the system further comprising a comparator (5) for comparing time shifted signals from the light sensors (9, 11).

2. System for detecting movement of a camera having a variable optical element as claimed in claim 1 wherein the system comprises one or more beam splitters for providing more than one pair of lights beams, wherein the system comprises for each beam splitter a corresponding pair of sensors (9′, 9″, 11′, 11″).

3. System for detecting movement of a camera having a variable optical element wherein it comprises a further variable optical element (51) which is positioned, seen in the optical path, behind the lens (2), the system further comprising at least one light sensor (9) for providing light signals, comprising a grating (9g) in the light path, wherein the variable element is arranged for changing as a function of time the position of the beam and the grating is respect of each other and the system further comprising a comparator for comparing time shifted signals from the sensor.

4. Camera comprising a system as claimed in claim 1.
